(19) United States
(12) Patent Application Publication
(10) Pub. No.: US 2014/0228062 A1
(43) Pub. Date: Aug. 14, 2014

(54) AUTOMATIC NOTIFICATION UPON TRIGGER DETECTION

(71) Applicant: APPLE INC., Cupertino, CA (US)

(72) Inventor: Amit Rubowitz, Modi'in (IL)

(73) Assignee: Apple Inc., Cupertino, CA (US)

(21) Appl. No.: 13/766,139

(22) Filed: Feb. 13, 2013

(51) Int. Cl. H04W 4/12

(52) U.S. Cl. CPC H04W 4/12
USPC 455/466

(57) ABSTRACT

A user device can be configured to monitor information about a device, such as a current power level, a signal reception level, a rate of power consumption. Upon detecting one or more triggers (e.g., the battery level of the device meeting a minimum threshold), the user device can determine one or more pre-specified contacts to send a notification. The user device can determine one or more information items to be sent to the one or more contacts. The one or more information items can be determined based on profile data associated with each contact. The user device can then send a notification message and the one or more information items to the one or more contact devices using the contact information. The user device can also send a confirmation request to determine whether the notification message has been received by the one or more contact devices.

### BACKGROUND

People are using portable electronic devices for an increasing number and variety of tasks. For example, a smartphone or tablet computer can perform tasks and offer functionalities similar to those performed or offered by a desktop or other such powerful electronic devices. As various portable electronic devices have increasingly enhanced functionalities, the amount of resources and power consumption required by these devices tend to increase. The battery life of current portable electronic devices are often unable to last beyond a short period of time without having a rechargeable source.

As the battery life shortens throughout the day, a user of a portable electronic device would need to constantly check the battery charge level to ensure that the user would maintain reachable or that a call would not end while the user is in the middle of a conversation. The constant monitoring becomes cumbersome and ineffective at times. As the conversation with another user may end abruptly due to a loss of battery life, the party on the other end of the call may be unaware of the reasons behind the sudden call termination. Other callers may also be unaware of the reasons why the user of the device has become unreachable.

### BRIEF DESCRIPTION OF THE DRAWINGS

FIG. 1 illustrates an example system of some embodiments for sending a message to one or more contacts in the event that a set of criteria has been satisfied.

FIG. 2 is a flow chart of illustrative process of some embodiments for sending a notification message and one or more information items to one or more identified contacts.

FIG. 3 illustrates an example of a notification message and additional information being received by a contact device upon the termination of a call.

FIG. 4 is a flow chart of illustrative process of some embodiments for sending a notification message to one or more contacts when a power level of a user device is below a threshold and when other devices belonging to the user is not within a vicinity of the user device.

FIG. 5 illustrates an example of a user configuration of a set of contacts to notify when a trigger has been detected and the types of information to send to each contact.

FIG. 6 is a flow chart of illustrative process for determining whether to send a notification message to a contact device according to some embodiments.

FIG. 7 illustrates a computer system according to an embodiment of the present invention.

### DETAILED DESCRIPTION

Aspects of the disclosure relate to systems and methods for sending a message to one or more contacts when a power level of an electronic device falls below a threshold value. In some embodiments, an electronic device can detect one or more triggers (e.g., a power level of the electronic device falling below a threshold, a reception signal strength falling below a threshold) and determine one or more contacts to which a notification message can be sent. When the trigger is detected, the electronic device can identify one or more types of information to obtain for each contact (e.g., a location of the device, a time at which the power level falls below the threshold) via a storage device. The types of information to obtain for each contact can be specified by profile data associated with each contact. Based on the identified type(s) of information, the electronic device can determine one or more information item(s) corresponding to the identified type(s) of information and send the information item(s) in addition to the notification message to each of the contacts.

In some embodiments, the user can preconfigure the device to identify different types of information for different contacts. As such, different contacts may receive different types of information depending on, for example, the relationship between the user and the contact. Further, the electronic device may request a confirmation that the various contacts have received the notification messages (and their respective information item(s)). Depending on whether the electronic device is still operable, the confirmation message may be received via a text message on the electronic device or transmitted to the user via other services (e.g., e-mail service) that the user may access using other devices.

The electronic device can be configured to send a message to a server when one or more criteria has been satisfied (e.g., the power level of the device has fallen below a threshold value of 5%). The server may send a notification to a contact with whom the user is communicating when the user device is determined to be no longer operable for communication (e.g., due to low power). The server can determine that the user device is no longer operable in a variety of ways, which may be combined or performed independently. For example, the server can determine that the user device is no longer operable by pinging the user device periodically. When the server determines that the use device is unresponsive (e.g., indicating that the power level of the device has fallen below a level at which the device can maintain communication, such as at 1% power level), the server can send the notification message to the contact to inform the contact that the user's device is no longer operational. As another example, the server can determine that the user device is no longer operable by determining whether a communication ended due to a voluntary ending of the communication (e.g., through the selection of an “end” button on the user device). For instance, when the network detects that the communication has ended, a server can be prompted to determine whether the communication ended by determining whether an “end” signal was received from one of the devices used in the communication or by detecting whether there is battery life remaining on the user device. If the network determines that the communication did not end voluntarily, the server can be prompted to send the contact a notification message.

Certain embodiments of the electronic device can predict whether the device is likely to run out of power before a communication between a user of the device and another user of another device ends. For example, the device might be able to determine that based on the duration of past conversations with the other device, the communication may last over an hour while the device has an estimated 10 minutes of power left at the current rate of power consumption. In such a situation, the device can be configured to automatically or upon user confirmation send a message to the electronic device and/or the other device to inform the users of the limited power level. In some embodiments, the device can further identify another device of the user that can be used to continue the communication between the user and the other user and present the identified device as an option to transfer and handle the communication.

Some embodiments can provide a user interface that allows the user of the electronic device to specify a number of people to which to send a notification message and/or information pertaining to the electronic device. For example, the user can identify one or more persons who the user would like contacted in the event that a trigger has been detected (e.g., when the power level of the device falls below a threshold). For instance, the user can select one or more persons from the user's contacts list or address book. The user can also specify the particular means (e.g., an e-mail, a phone number) that the user would like the notification and/or information sent to those identified contacts. In one embodiment, the user can configure the device to send multiple notifications and/or of different types (e.g., text message, e-mail message), at different time intervals, to the identified contact(s).

As described, certain embodiments enable the user to specify the type of information to send to the identified person(s). For different contacts, the user may prefer to send different types of information when the trigger has been detected. For example, the user may want to send another phone number at which the user may be contacted to a contact with whom the user is currently in communication. For another contact, such as a parent of the user, the user may desire to send a current location of the user's device along with the notification message. Different types of information and different types of messages/notifications may be sent to different contacts. The user may preconfigure and customize the types of information and/or messages to send to those contacts via an application, a preference setting, or a system configuration on the user's device.

As described, when a set of criteria is met by the user device (e.g., the user's device is low on battery at 10%), a notification can be presented to the user where the user may specify a number of people to whom the user would like a notification and/or additional information sent. Instead of automatically determining and sending information to a set of contacts pre-specified by the user, the user's device may present a low power warning to the user and request the user to identify a list of contacts and the type of information to send to those contacts. In some embodiments, the user's device may automatically determine and present the contacts and the types of information to send based on past selections. For example, the device may determine that the user has selected to send location information to a particular contact in addition to the low power notification during previous low power events and determine that the user may desire to send the same type of information to the particular contact at this event.

When a trigger has been detected in some embodiments, a user device can broadcast a warning to the user and a contact with whom the user is currently communicating. For instance, a warning or a notification, such as a series of audio alerts, a flashing light, or a message displayed on a screen, can be provided to the user and/or the contact such that the user and the contact can be prompted to finish the conversation within the limited time period or switch to a different means of communication. In some embodiments, the user device can broadcast multiple warnings in certain time intervals. The magnitude of each warning can also be escalated as the power level decreases or for each subsequent broadcasted warning.

In some embodiments, upon determining that a series of criteria has been satisfied (e.g., a power level of the device has fallen below a threshold value), the user device may determine whether another device is within a vicinity of the user device. For example, the device may determine whether another electronic device associated with the user device (e.g., registered user the same user account, belonging to the same user) is within a threshold distance of the user. As such, the device may not send out the notification message as the user has ready access to other devices that the user may use to contact the contact(s) in the event of a power loss. Further, the user device may identify a current location of the user device (e.g., via global positioning system (GPS), via an access point detection, via a network connection), and determine not to send out the notification message as the user may have ready access to other devices that can be used to reach the contact(s). For example, the user device may identify that the user's current location is in the user's home or office and determine that the user may have ready access to other communication devices (e.g., an office phone, a landline at home).

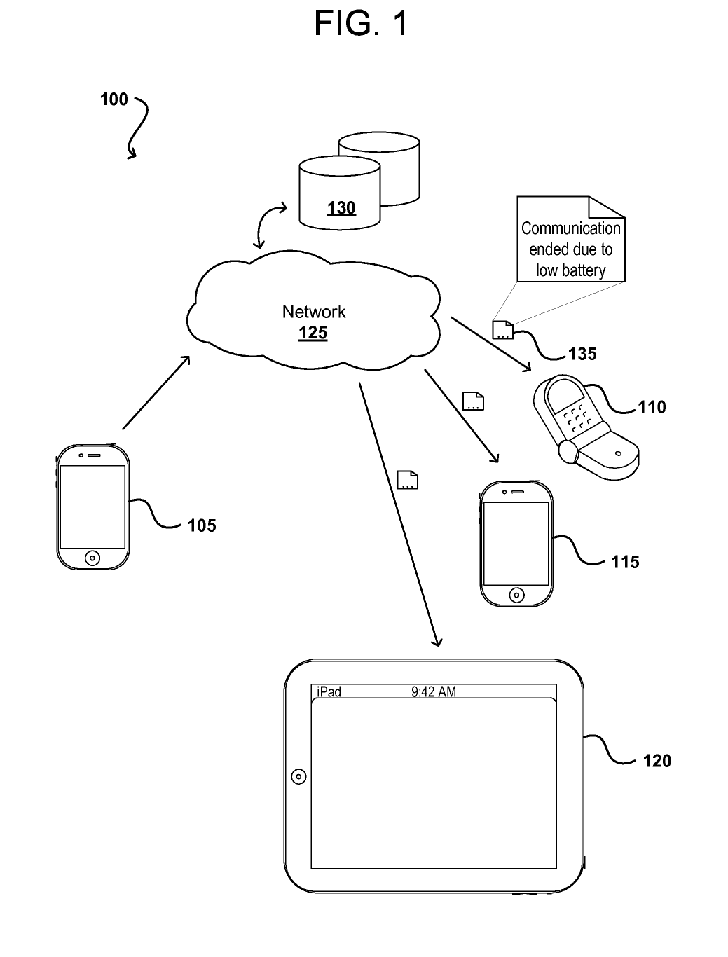

Various embodiments will now be discussed in greater detail with reference to the accompanying figures, beginning with FIG. 1.

### I. System Overview

FIG. 1 illustrates an example system 100 of some embodiments for sending a message to one or more contacts in the event that a trigger has been detected (e.g., when a power level has fallen below a threshold value). System 100 can include an electronic device 105 belonging to a participant user (also referred to as a contact), one or more electronic devices 110-120 belonging to one or more contacts, a communication network 125, and one or more databases 130 accessible via the communication network 125.

In some embodiments, one or more components of system 100 can be combined or omitted. In one example, the user of electronic device 105 can have multiple electronic devices not shown in FIG. 1 that can be detected by electronic device 105, in the event that electronic device 105 is low on battery. Upon detecting another device associated with the user of electronic device 105, electronic device 105 may not send the notification message to one or more electronic devices 110-120 as the user has access to another communication device. In another example, network 125 can be any single network or a combination of networks and can include various components, such as one or more servers not shown in FIG. 1.

Electronic devices 105-120 can include any suitable type of electronic device operative to communicate with one or more electronic devices. For example, electronic devices 105-120 can include any of a variety of communication-enabled devices, including, but not limited to, a mobile telephone, a portable media player, a personal digital assistant (PDA), a networked personal computer (PC), a smartphone, a tablet computer, a laptop computer, or other device. Some or all of electronic devices 105-120 can include a wireless terminal. In the example of FIG. 1, the electronic device 105 is illustrated as a data-enabled cellular phone and the other devices 105-120 are illustrated as a mobile phone 110, a smartphone 115, and a tablet computer 120, each with communication capabilities operable via various communication services such as cellular communication services, text messaging services, video conferencing services, and voice over Internet protocol (VoIP) services.

In some embodiments, communications network 125 can include one or more network portions for communicating data and other signaling, including one or more private network portions, one or more public network portions, or a combination thereof. Communication over communications network 125 can be enabled via wired or wireless connections and combinations thereof. The wired network can include the Internet, a private Internet-Protocol (IP)-based network, etc. and the wireless network can include a cellular network, a wireless local area network (WLAN), and the like. Although not shown in this example, system 100 can include one or more servers (e.g., a Web server, an application server, a base station controller) that can receive/send requests and/or responses to and from various devices.

Electronic devices 105-120 can communicate with other devices within communications network 125 using any suitable communications protocol, such as WiFi (e.g., a 802.11 protocol), Bluetooth®, cellular networks (e.g., GSM, CDMA, EDGE, LTE, or any other suitable cellular network or protocol), TCP/IP (e.g., any of the protocols used in each of the TCP/IP layers), HTTP, FTP, VoIP, any other communications protocol, or any combination thereof. When electronic devices 105-120 include a wireless device, the electronic devices can connect to the IP network and other wireless communication networks through WiFi, Bluetooth, and other local area networks, including any suitable wired or wireless communications link or path (or a combination of these).

In the example illustrated in FIG. 1, communications network 125 can have access to one or more databases 130 storing data including notification distribution information, contact information, records of past communications with various contacts, etc. One or more servers (not shown) that are part of communications network 125 can access one or more databases 130 to retrieve information as requested by user device 105. The one or more servers, in one embodiment, can monitor certain characteristics of user device 105 (e.g., a power level, a reception signal, etc.) and determine when to send or forward a notification message to one or more receiver devices 110-120. The monitored characteristics can include characteristics that stimulate, or trigger, a notification message to be sent to one or more devices 110-120.

In some embodiments, a server can receive an indication, or a trigger, from user device 105 that a power level of user device 105 is running low and therefore a notification message should be forwarded to one or more of devices 110-120. The server can then send a message and/or additional information to one or more of devices 110-120. In some embodiments, when the server receives an indication that the power level of user device 105 is low, the server can identify one or more contacts that a user of user device 105 has specified that the user would like contacted. The server can then determine the appropriate information to send to each contact and send the notification message to those identified contacts. The notification message can serve as either a warning that user device 105 is running low on battery or as an explanation why a call was abruptly terminated.

In some embodiments, user device 105 can detect a trigger for a notification message to be sent. The trigger that can stimulate user device 105 to cause a notification to be sent to one or more devices includes a power level falling below a threshold, a signal level or reception signal strength falling below a threshold, a user command, a location detection (e.g., via global positioning system (GPS), wireless triangulation, or cellular triangulation), etc. While in this example user device 105 monitors characteristics of the device and detects the trigger, a server or another device (e.g., within a threshold distance of user device 105) may perform the monitoring and the detection of the stimulus in some embodiments.

When a trigger has been detected, user device 105 or server (not shown) can identify one or more contacts who a user of user device 105 may want contacted. In some embodiments, the user of user device 105 may be prompted (e.g., via a pop-up screen) to enter or identify the one or more contacts (e.g., by inputting identifying information of the one or more contacts) in response to detecting the trigger. User device 105 in some embodiments may determine that a contact device (e.g., device 110) with which the user device is currently in communication to be a contact to which the user of user device 105 may want the notification message to be sent. Further, some embodiments determine the one or more contacts by accessing a database (e.g., database 130) that includes a set of pre-defined contacts that the user would like a notification message to be sent to when the trigger has been detected. Upon detecting the trigger, user device 105 or server may automatically identify the one or more contacts to which the notification message should be sent.

When user device 105 is no longer available (e.g., due to low power, due to poor signal reception), a server (not shown) that is part of network 125 can cause one or more notification messages 135 to be sent to the one or more identified contacts. The notification message can notify the one or more identified contacts that the user of user device 105 is no longer available, and in some instances, the reason why the user is no longer available. In some embodiments, the notification message can be sent to the one or more contact devices along with an alternative means that the user can be reached. For example, the notification message indicating that the user is no longer available via user device 105 can further indicate another home phone number where the user can be reached in response to a determination that user device 105 is currently at the user's home.

Further, additional notification messages can be sent to the one or more contact devices 110-120 at the same time. Different types of messages (e.g., e-mail message, SMS message) can be sent to the one or more contact devices such that the user may be informed via different methods. Further, multiple notification messages can be sent to the one or more contact devices in periodic intervals. The intensity of the notifications/messages can increase as the device becomes less available. In one example, the device may receive a text message when 10% of the power level remains and receive a flashing light signal and an announcement when 3% of the power level is remaining. In another example, the device may receive one e-mail message when the device is at 20% of the power level and receive a text message in addition to another e-mail message when the device is at 10% of the power level.

In some embodiments, user device 105 may determine an appropriate type of message to send based on contact information associated with the one or more devices 110-120. For instance, a user of contact device 110 may have pre-specified a preferred type of message to receive. Further, in some embodiments, user device 105 may determine (e.g., via GPS, via other location determination mechanisms) that user device 105 is located near another electronic device belonging to the user and thereby cause the notification message not to be sent to the one or more devices 110-120. In the event that another device associated with the user (e.g., via a registered account) may be detected to be within the vicinity of user device 105, the notification message may be refrained from being sent since the user can use the other device to contact the one or more contact devices 110-120 and explain the reason for the call termination.

In some embodiments, user device 105 (or server) can determine a type of device of the one or more devices 110-120 and determine the appropriate type of message to send to those devices. For example, user device 105 may determine that one of devices 110-120 is a home phone or a landline and thereby send the notification in an e-mail format instead of a text message format. Further, user device 105 may determine that a text message or a voice message is more appropriate for different types of devices such as a mobile device 110 and therefore send the appropriate types of notification messages.

As described, a server (not shown) that is part of network 125 can send the notification to one or more of contact devices 110-120 in response to receiving an indication that user device 105 may no longer be available. Upon receiving the indication that user device 105 is no longer available or upon detecting the trigger that the power level is below a threshold level, the server or other component of network 125 can determine whether the communication ended due to a low battery of user device 105 or due to an intentional termination of the conversation. In some embodiments, the determination can be made by assessing whether user device 105 has remaining battery life and/or whether the user of user device 105 or contact devices 110-120 has pressed an “end” button on the device to end the communication. If the server determines that the communication did not end intentionally, then the server may send the notification message to at least one of contact devices 110-120 to indicate that the communication terminated due to low battery.

As described above, in addition to notification messages, user device 105 or a server (not shown) can determine various types of information to be determined for the one or more contact devices 110-120. Upon accessing storage device (e.g., a database 130) or local storage on user device 105, user device 105 can determine one or more information items to be obtained and sent to respective devices 110-120. As such, location information, time information, a voice recorded message, information retrieved from the user's calendar (e.g., the user is currently in a meeting), etc. can be determined and sent to respective devices 110-120, as specified by the user.

If user device 105 and contact devices 110-120 were not in the middle of a communication when user device 105 becomes unavailable, a component (e.g., a server) in network 125 can send the notification message to at least one of devices 110-120 to inform the users of devices 110-120 that user device 105 has become unavailable. The user of user device 105 can preconfigure the setting such that certain people are informed when user device 105 is low on battery. As such, the user of contact devices 110-120 (e.g., a parent) may be aware of the reason that the user of user device 105 has become unavailable and not be concerned about the unreachability or unavailability of the user.

In some embodiments, a notification message can be sent to a contact device when a length of communication between two devices may exceed an amount of time that the power level of user device 105 can withstand. User device 105 or a server can predict how long the conversation may last between the user of the device and the other user of the contact device. The duration of the communication can be estimated by accessing historical communication data between the two users via database 130. Database 130 may record the time duration of the past communications between the two users and thereby allow user device 105 or server to compute an estimated duration of the current communication. Upon determining that the length of the current communication may exceed that permitted by the current power level, user device 105 or server may send a notification message to user device 105 and/or the contact device to warn the users of the possibility of communication termination due to low power.

### II. Flow Overview

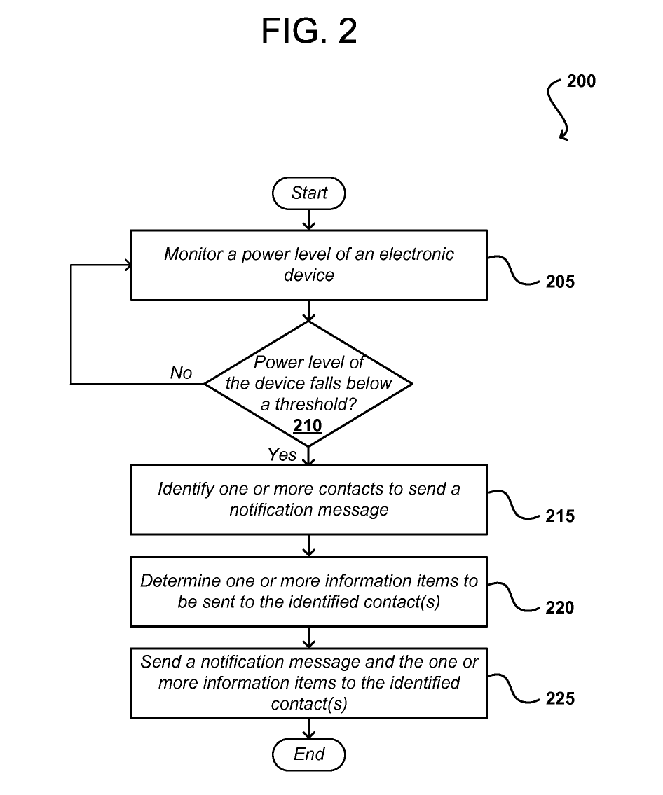

As described above, a user device in some embodiments can send a notification message to a contact device when a power level of the user device has fallen below a threshold level. FIG. 2 is a flow chart of illustrative process 200 of some embodiments for sending a notification message and one or more information items to one or more identified contacts. Process 200 can be performed by a single device (e.g., device 105 in FIG. 1), a server (e.g., server component accessible via network 125 in FIG. 1), or any suitable combination of servers and devices. Process 200 can begin at block 205.

As shown at block 205, a power level of an electronic device (also referred to as a user device) can be monitored. In some embodiments, a user device or a server can monitor a power level or a battery charge level of the device to determine whether the power level has fallen below a threshold value. The power level can be checked periodically from time to time. Instead of monitoring a power level of an electronic device, some embodiments may monitor one or more other parameters of the electronic device, such as a signal reception, receipt of a voice command, etc.

At block 210, a determination can be made as to whether the power level of the device has fallen below a threshold. In some embodiments, the determination can be made by the user device or the server. The monitored power level can be compared against a predetermined threshold to determine whether the power level has fallen below the threshold. If the power level of the device has not fallen below the threshold, the power level of the device can continued to be monitored at block 205. If the power level of the device has been determined to fall below the threshold, at block 215, one or more contacts can be identified.

In some embodiments, the user device can identify one or more contacts to send a notification message. The notification message can notify the contact(s) that the power level of the device has fallen below a threshold. For example, the notification message can indicate that the device has run out of batteries and is currently inoperable for communication. In some embodiments, a user of the user device can specify a list of contacts that the user would like to notify when the power level falls below the threshold. The user device in some embodiments can present a user interface through which the user can select and/or identify the list of contacts.

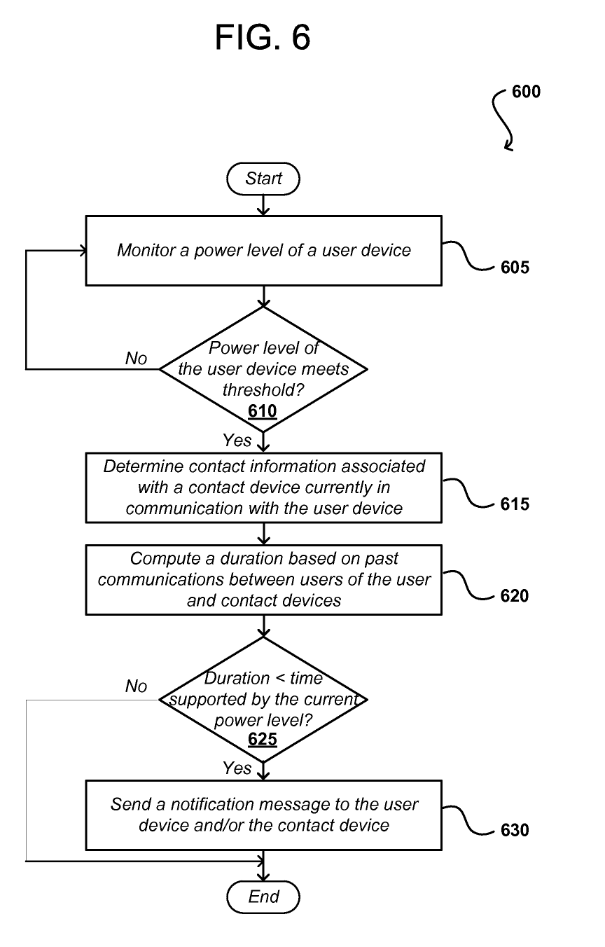

At block 220, one or more information items to be sent to the identified contact(s) can be determined. In some embodiments, the user device or the server can determine one or more information items based on the identified contacts. The user device in some embodiments provides a user interface (such as the user interface shown in FIG. 6) that enables the user to specify the information items that the user would like sent to each contact. Different types of information can be determined and presented to the identified contacts. For example, the user may specify for the device to send information including a current location and a current time to a parent when the power level of the device falls below the threshold while specifying for the device to send only the notification message to another contact.

At block 225, a notification message and the one or more information items can be sent to the identified contact(s). The user device or the server can send the notification message and the one or more information items to the identified contact(s). In some embodiments, the user device may specify for the server to send the notification message and the one or more information items to the identified contact(s) when the power level of the device has been detected to reach another threshold. As such, the user of the contact device may be notified of the reason that a communication has been terminated after the communication has ended.

Although in this example, a notification message is configured to be sent to a contact device when the power level of a user device falls below a threshold, the notification message may be sent to the contact device upon detecting one or more other triggers. As such, the notification message may inform the contact of one or more other reasons that may have caused the communication to end. For example, a notification message indicating that the user device has become unavailable due to poor signal reception can be received by the contact device. In some embodiments, the user device may monitor a number of parameters (e.g., signal reception, location, etc.) and determine a probable cause for potential termination of a communication and cause a notification message identifying the reason to be sent to the contact device, for example, when the call has been terminated. Different embodiments may include different types of information within and to be sent along with a notification message.

Some or all of process 200 (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program to be executed by processing unit(s), such as a browser application. The computer-readable storage medium may be non-transitory.

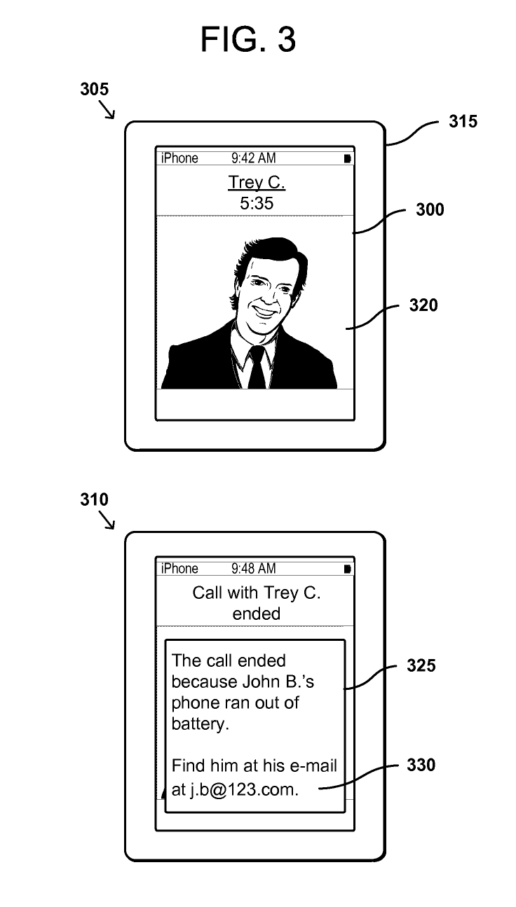

FIG. 3 illustrates an example of a notification message 325 being received by a contact device 315 upon the termination of a call. FIG. 3 illustrates two stages 305 and 310 of GUI 300 of contact device 315 for receiving a notification message 325 along with additional information 330 related to the user device when a call has been terminated, for example, due to low battery. GUI 300 includes a display area 320 for displaying an image of a user (i.e., Trey C.) of user device who is currently in communication with a contact of the contact device. The image can be a static image previously captured and stored on the device or a real-time capture of video images.

The first stage 305 shows an ongoing communication (e.g., a video chat) between a user (i.e., Trey C.) of user device and a user of contact device 315. The second stage 310 shows the contact device receiving a notification message 325 subsequent to receiving an indication that the call with the user of the user device has ended. Notification message 325 indicates a reason that the call ended. In this example, the user device has identified that the reason the call ended was due to low power of the device. Further, in addition to notification message 325, additional information 330 regarding an alternative method (e.g., an e-mail address) in which the user of the contact device can reach the user of the user device is provided. In some embodiments, the additional information determined for the particular contact can be included as part of the notification message or can be a separate message.

While in this example a notification message along with additional information related to the user device are provide to the user of the contact device subsequent to receiving an indication that a communication has ended, some embodiments provide warning messages prior to the termination of the communication. For example, some embodiments provide warning messages to the user of the user device and the user of the contact device when a power level of the user device reaches one or more threshold levels (e.g., 20% power level, 10% power level). In some embodiments, the warning messages can be announced to the users on the users' devices in a fashion that would make the users aware of the potential termination in communication. In addition to a warning announcement, additional warnings such as flashing lights or a vibration can be presented by the users' devices simultaneously to receiving the warning message.

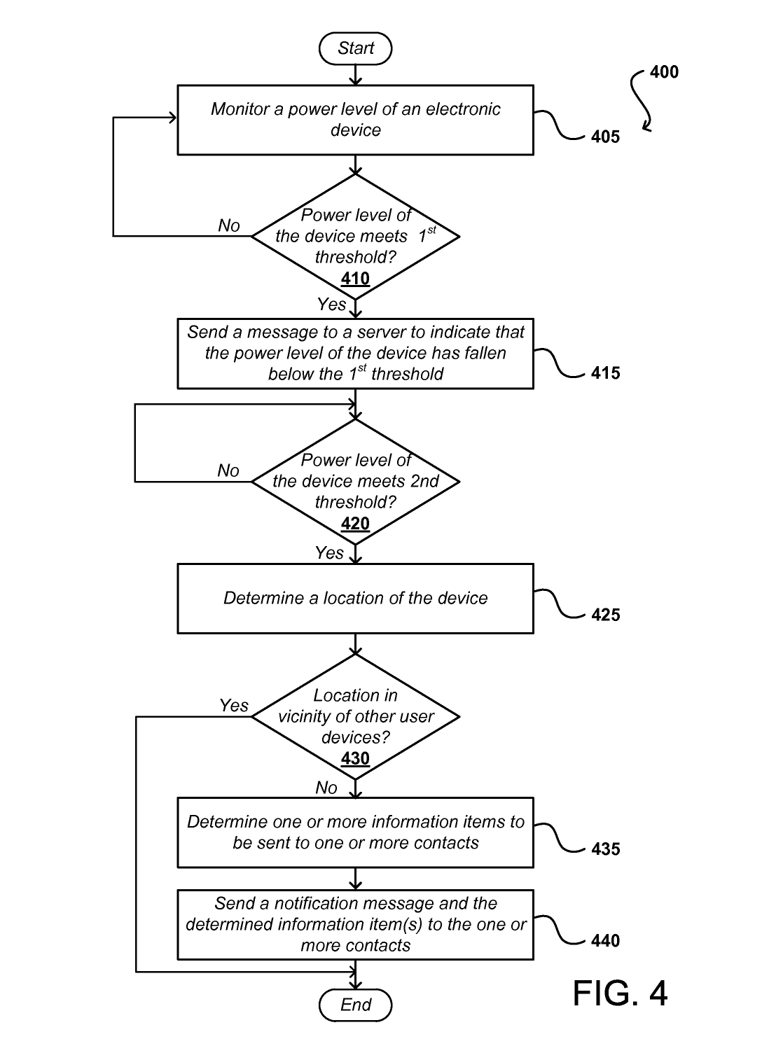

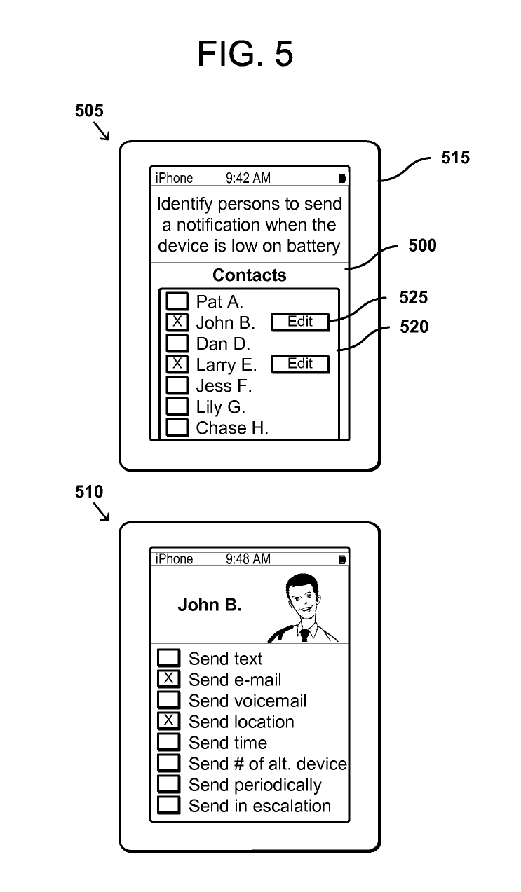

FIG. 4 is a flow chart of illustrative process 400 of some embodiments for sending a notification message to one or more contacts when a power level of a user device is below a threshold and when other devices belonging to the user is not within a vicinity of the user device. Process 400 can be described by reference to FIG. 5, which illustrates an example of a user configuration of a set of contacts to notify when a trigger has been detected and the types of information to send to each contact. FIG. 5 illustrates two stages 505 and 510 of GUI 500 of user device 515 for enabling a user to specify or preconfigure a set of contacts to notify in the event that a low power level is detected and the types of information to send to each individual.

In some embodiments, prior to sending out a notification message to the user device, a user device can determine whether there are devices associated with the user (e.g., registered under a same account, associated with a same username) within a vicinity of the user device. If another device is detected, the user device may not send a notification message to the contact device. The user can use the other devices to inform the contact of the reason of the call termination.

At block 405, a power level of an electronic device can be monitored. As mentioned, the power level can be monitored locally at the user device or by a remote server.

At block 410, a determination as to whether the power level meets a first threshold can be made. The first threshold can be a threshold preconfigured by a user or an administrator at, for example, 20% of the power level. At block 415, a message indicating that the power level of the device has fallen below the first threshold can be sent to a server. In response to detecting that the power level of the user device has fallen below a threshold value, the user device can send a signal to the server to trigger the server to monitor the power level of the user device.

At block 420, a determination as to whether the power level of the user device has met a second threshold can be made. In some embodiments, a server can monitor the power level of the user device by pinging the user device periodically. The server can ping the user device to determine whether the user device is responsive in predetermined intervals. In some embodiments, the server can determine that the power level of the user device has met the second threshold level when the server no longer receives a response from the pinging or when the server fails to receive a response within a threshold period of time. The threshold period of time can be preconfigured by a user or an administrator in some embodiments.

At block 425, a location of the device can be determined. In some embodiments, a user device or a server can determine a location of the user device based on any of a number of location determination mechanisms, such as global positioning system (GPS) on the user device, triangulation techniques, a network connection, etc.

At block 430, a determination can be made as to whether the determined location of the user device is within a vicinity of other user devices. In some embodiments, the user device can detect whether any devices associated with the user is within a threshold distance of the user device (e.g., by determining the location of the other devices or by determining whether any of the devices are connected to a same Wi-Fi network as the user device). A device can be associated with the user if the device also belongs to the user or is registered under a same account. In some embodiments, the device need not be associated with the user and may simply be a communication device that is accessible to the user. If it is determined that another device may be within a vicinity of the user device, then process 400 ends.

In some embodiments, the user device may determine that the user device is within a vicinity of other devices associated with the user when the user device is determined to be currently residing at the user's address, work, or another location where the user may likely have other communication devices or home phones (e.g., via Wi-Fi, via GPS location). If it is determined that the user device is in a location where the user may likely have other communication devices such that the user may use those device(s) to contact a contact, then process 400 ends. In some embodiments, in response to the determining that the user device is currently located at the user's home or work location, the user device may still send the notification message to the one or more contacts to inform the contact(s) that the user device is low on battery. Further, the user device in some embodiments may send additional information (or include the additional information in the notification message) indicating that the user may contact the contact from another device that has been detected to be within the vicinity of the user device. An identifier for the other device, such as a phone number or indication of it being a home or office landline, may be included in the message.

At block 435, if it is determined that the location of the user device is not within a vicinity of other user devices, then one or more information items to be sent to one or more contacts can be determined. As described, the one or more information items to be sent to the one or more contacts can be pre-identified by the user of user device (e.g., user device 105 in FIG. 1). As shown in FIG. 5, GUI 500 of user device 515 enables the user to identify one or more contacts to be notified in the event that a power level of user device 515 falls below the threshold level. GUI 500 includes a display area 520 for displaying a set of contacts (e.g., retrieved from the user's address book or contacts list).

The set of contacts can be retrieved locally from storage on user device 515 or populated from a remote storage location. The contacts can further be populated from various services with which the user has an account or is subscribed. For example, the list of contacts can be retrieved from a social networking website or account under which the user is subscribed. As the list can include contacts obtained across various communication services (e.g., cellular communication service, VoIP service, social networking service), the method in contacting those contacts can be different depending on the services with which these contacts are associated.

As shown in the first stage 505, the user can identify those contact that the user would like notified in the event that the device is low on battery. In this example, John B. and Larry E. have been selected by the user to be notified in such an event. The user may further edit the types of notification and/or information to be sent to each contact by selecting user-selectable interface item 525. The second stage 510 shows the types of notifications and information to be sent to the contact John B. after the user has selected interface item 525. The user has indicated a selection of e-mail message as the method in notifying the contact and a location as additional information to determine and send to the contact when the device is detected to have low power. The type of information to obtain and send to the contact is stored as profile data associated with the contact. In this example, the location of the user device is identified in the profile data associated with the contact as one of the information items to be sent to the contact when a trigger has been detected. While in this example, only a few options are shown, additional options in which to customize the type of message, the type of information, and/or a method in sending the message and/or information can be provided in various embodiments.

Returning to FIG. 4 at block 440, the notification message and the determined information item(s) can be sent to the one or more contacts. In some embodiments, the types of notification message sent to a particular contact can be determined based on profile data associated with the particular contact. For example, the profile data may indicate that the contact may typically desire a particular type of message (e.g., e-mail message, text message) to be sent to the contact or that the user may desire to send the particular type of message to the contact. In some embodiments, the type of notification message sent to the one or more contacts can be determined based on historical data. For example, the user may have sent the particular contact messages of a particular type or service (e.g., via an application service such as AIM®, a VoIP service such as Skype®) in the past. Based on previous messages sent to the particular contact, the user device may determine and send the same type of notification message to the particular contact.

As previously described, some embodiments may send multiple notification messages to the one or more contacts. The user device may send multiple types of notification messages (e.g. e-mail message, SMS message) to a particular contact simultaneously or in sequential order. The number of messages and the types of messages may be specified by the profile data associated with each contact. Different contacts may receive different types of notification messages at different time intervals.

In some embodiments, a notification message can be sent to a user device and/or a contact device in the event that a duration of a current communication may be estimated to be longer than the duration permitted by the current power level of the user device. FIG. 6 is a flow chart of illustrative process 600 for determining whether to send a notification message to a contact device according to some embodiments. At block 605, a power level of a user device can be monitored. At block 610, a determination can be made as to whether the power level of the user device meets a threshold. As described above, a user device in some embodiments can determine whether the current power level is below a predetermined threshold level. If the power level is determined not to be below the threshold level, process 600 can return to block 605 and continue to monitor the power level of the user device.

If the power level is determined to meet a threshold level, at block 615, contact information associated with a contact device currently in communication with the user device can be determined. In some embodiments, a user device can determine the contact information based on a device identifier or a phone number. The user device can match a device identifier or a phone number with contact information stored on the user device or contact data stored remotely.

At block 620, a duration can be computed based on past communications between the user of the user device and the user of the contact device. The contact data may store information relating to past communications between the users. In some embodiments, a time duration of a typical communication between the users can be computed based on the contact data. Some embodiments can compute the duration by taking a current time, a current location, a date into consideration when computing the duration. As such, the duration that the current communication would likely last can be more accurately calculated. For example, if past communications during the work day between the two users is 5 minutes, for example, during a break from work, then upon determining that the current communication is taking place during work hours, the user device may compute the duration to be 5 minutes.

At block 625, a determination can be made as to whether the computed duration is less than (or equal to) the time supported by the current power level. In some embodiments, the user device can estimate a duration that the current power level can support. The user device can determine a current power level and a rate at which the power level is declining to estimate a time length at which the current power level would last. A comparison between the computed duration and the estimated duration can be made to determine whether the current communication would potentially end before the battery life of the user device ends. If the current communication is estimated to end before the battery life ends, then process 600 ends.

If the current communication is estimated to last longer than the available battery life of the user device, then at block 630, a notification message can be sent to the user device and/or the contact device. As such, a warning can be provided to the user device and/or the contact device if the current power level would likely not permit the current communication to last. In some embodiments, the notification message can be sent in the beginning of the communication to warn the user(s) to finish the communication quickly. Some embodiments send notification messages in periodic time intervals to constantly warn the user(s) that the power level may not last throughout the estimated duration of the communication.

In some embodiments, multiple types of notification messages can be sent at the same time. Different types of notification messages can be sent to the user and/or contact devices since different people pay attention to different types of messages. For example, the contact device can receive both an e-mail and a text message. In another example, the contact device can receive a text message and be caused to flash warning lights. The user device or the server can cause two or more messages to be sent in response to determining that the power level may be insufficient for the current communication to catch the contact's attention. In some embodiments, the types of messages that the user of the device would prefer to receive can be preconfigured. Further, the server can determine based on past behavior that the contact is more responsive to certain types of notifications and send the determined types of notifications to the contact device.

In some embodiments, the intensity or the degree of the warnings or notification messages can be sent in an escalating manner. As the power level of the user device decreases (e.g., from 20% to 10% power level), the warnings can escalate from a low buzzing tone or a mild vibration to a shrill or loud ring or a strong vibration. The types of notification messages can also change from an e-mail message to a text message. As such, the user of the user device and/or the user of the contact device may be properly warned that the power level of the user device may be running low and that an alternative means of communication may be necessary.

### III. Computer System

Many of the above-described features and applications can be implemented as software processes that are specified as a set of program instructions encoded on a computer readable storage medium. When these program instructions are executed by one or more processing units, the program instructions cause the processing unit(s) to perform the actions indicated in the instructions. Examples of computer readable storage media include CD-ROMs, flash drives, RAM chips, hard drives, EPROMs, etc. The computer readable storage media does not include carrier waves and electronic signals passing wirelessly or over wired connections. “Software” refers generally to sequences of instructions that, when executed by processing unit(s) cause one or more computer systems to perform various operations, thus defining one or more specific machine implementations that execute and perform the operations of the software programs.

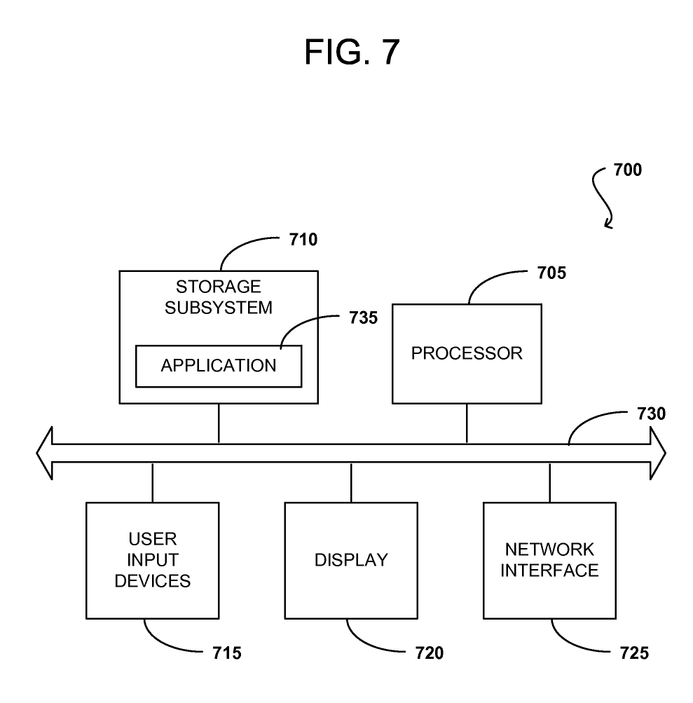

FIG. 7 illustrates a computer system 700 according to an embodiment of the present invention. System 100 in FIG. 1 includes several electronic devices (e.g., electronic devices 105-120 in FIG. 1) that can be implemented within a computer system such as computer system 700 shown here. Computer system 700 can be implemented as any of various computing devices, including, e.g., a desktop or laptop computer, tablet computer, smart phone, personal data assistant (PDA), or any other type of computing device, not limited to any particular form factor. Computer system 700 can include processing unit(s) 705, storage subsystem 710, input devices 715, display 720, network interface 725, and bus 730.

Processing unit(s) 705 can include a single processor, which can have one or more cores, or multiple processors. In some embodiments, processing unit(s) 705 can include a general-purpose primary processor as well as one or more special-purpose co-processors such as graphics processors, digital signal processors, or the like. In some embodiments, some or all processing units 705 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 705 can execute instructions stored in storage subsystem 710.

Storage subsystem 710 can include various memory units such as a system memory, a read-only memory (ROM), and a permanent storage device. The ROM can store static data and instructions that are needed by processing unit(s) 705 and other modules of electronic device 700. The permanent storage device can be a read-and-write memory device. This permanent storage device can be a non-volatile memory unit that stores instructions and data even when computer system 700 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 710 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 710 can include removable storage media that can be readable and/or writeable; examples of such media include compact disc (CD), read-only digital versatile disc (e.g., DVD-ROM, dual-layer DVD-ROM), read-only and recordable Blue-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 710 can store one or more software programs to be executed by processing unit(s) 705, such as an application 735. As mentioned, “software” can refer to sequences of instructions that, when executed by processing unit(s) 705 cause computer system 700 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 710, processing unit(s) 705 can retrieve program instructions to execute and data to process in order to execute various operations described herein.

A user interface can be provided by one or more user input devices 715, display device 720, and/or and one or more other user output devices (not shown). Input devices 715 can include any device via which a user can provide signals to computing system 700; computing system 700 can interpret the signals as indicative of particular user requests or information. In various embodiments, input devices 715 can include any or all of a keyboard touch pad, touch screen, mouse or other pointing device, scroll wheel, click wheel, dial, button, switch, keypad, microphone, and so on.

Display 720 can display images generated by electronic device 700 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 720. Examples include indicator lights, speakers, tactile “display” devices, printers, and so on.

In some embodiments, display 720 can provide a graphical user interface, in which visible image elements in certain areas of display 720 are defined as active elements or control elements that the user selects using user input devices 715. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 725. Other user interfaces can also be implemented.

Network interface 725 can provide voice and/or data communication capability for electronic device 700. In some embodiments, network interface 725 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 725 can provide wired network connectivity (e.g., Ethernet) in addition to or instead of a wireless interface. Network interface 725 can be implemented using a combination of hardware (e.g., antennas, modulators/demodulators, encoders/decoders, and other analog and/or digital signal processing circuits) and software components.

Bus 730 can include various system, peripheral, and chipset buses that communicatively connect the numerous internal devices of electronic device 700. For example, bus 730 can communicatively couple processing unit(s) 705 with storage subsystem 710. Bus 730 also connects to input devices 715 and display 720. Bus 730 also couples electronic device 700 to a network through network interface 725. In this manner, electronic device 700 can be a part of a network of multiple computer systems (e.g., a local area network (LAN), a wide area network (WAN), an Intranet, or a network of networks, such as the Internet. Any or all components of electronic device 700 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 705 can provide various functionality for electronic device 700. For example, processing unit(s) 705 can execute application 735 that can provide various functionality such as the ability to detect a trigger (e.g., a power level of the device), the ability to enable a user to specify which contacts to notify in the event a trigger is detected and the types of information to send to those contact, or the ability to detect devices associated with the user of device 700 within a vicinity of device 700, and so on. In some embodiments, application 735 can cause one or more notifications to be sent to the various contacts and can obtain the corresponding information to be sent to the various contacts.

It will be appreciated that computer system 700 is illustrative and that variations and modifications are possible. Computer system 700 can have other capabilities not specifically described here (e.g., global positioning system (GPS), power management, one or more cameras, various connection ports for connecting external devices or accessories, etc.). Further, while computer system 700 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

What is claimed is:

1. A method comprising:
determining, by a user device, that a battery level of the user device is below a threshold value;
in response to determining that the battery level of the user device is below the threshold value, determining one or more contact devices to send a notification message;
determining contact information for the one or more contact devices;
determining one or more information items to be sent to each of the contact devices, the one or more information items determined based on profile data associated with each of the one or more contact devices; and
sending a notification message and the one or more information items to the one or more contact devices using the contact information.

2. The method of claim 1, wherein the profile data associated with the contact information specifies the one or more information items to be determined and sent to the contact device.

3. The method of claim 2, wherein the one or more information items includes at least one of a current location of the user device, contact information of another device belonging to a user of the user device, or a timing information.

4. The method of claim 1, wherein the one or more contact devices includes a first contact devices and a second contact device, and wherein the one or more information items sent to a first contact device is different from the one or more information items sent to a second contact device.

5. The method of claim 1, wherein the notification message includes an indication that the battery level of the user device is low.

6. The method of claim 1, further comprising:
determining historical information associated with the contact information, the historical information including a type of notification that was previously sent to the contact device, wherein the notification message sent to the contact device is determined based on the historical information.

7. The method of claim 1, wherein the notification message is a first type of message, the method further comprising:
sending an additional message to the contact device, the additional message being a second type of message different from the first type of message.

8. The method of claim 1, wherein the type of notification message includes one of an e-mail message, a short messaging service (SMS) message, a text message, a voice message, and an instant message (IM).

9. A system comprising:
one or more processors;
a memory device coupled to the one or more processors, the memory device including a set of instructions to be executed, wherein the set of instructions, when executed by the one or more processors, causes the one or more processors to:
determine that a battery level of a user device is below a threshold value;
in response to determining that the battery level of the user device is below the threshold value, determine one or more contact devices to send a notification message;
determine contact information for the one or more contact devices;
determine one or more information items to be sent to each of the contact devices, the one or more information items determined based on profile data associated with each of the one or more contact devices; and
send a notification message and the one or more information items to the one or more contact devices using the contact information.

10. The system of claim 9, wherein the set of instructions that causes the one or more processors to send the notification message to the contact device includes a subset of instructions that causes the one or more processors to cause the notification message to be broadcasted by the contact device.

11. The system of claim 9, wherein the one or more information items includes a current location of the user device.

12. The system of claim 9, wherein the set of instructions further causes the one or more processors to:
identify the contact device in response to determining that the battery level of the user device is below the threshold value.

13. The system of claim 9, wherein the set of instructions further causes the one or more processors to:
receive a confirmation message that the notification message has been received by the contact device.

14. A non-transitory computer readable medium encoded with a set of instructions, which when executed by one or more processors, causes the one or more processors to perform a method, the method comprising:
determining that a battery level of a user device is below a threshold value;
in response to determining that the battery level of the user device is below the threshold value, determining one or more contact devices to send a notification message;
determining contact information for the one or more contact devices;
determining one or more information items to be sent to each of the contact devices, the one or more information items determined based on profile data associated with each of the one or more contact devices; and
sending a notification message and the one or more information items to the one or more contact devices using the contact information.

15. The computer readable medium of claim 14, wherein the method further comprises:
sending an additional message to the contact device, the additional message being of a different type of message compared to the notification message

16. The computer readable medium of claim 14, wherein the method further comprises:
sending an additional message to the contact device a threshold period of time prior to sending the notification message, wherein the notification message serves as an escalated warning to a user of the contact device.

17. The computer readable medium of claim 14, wherein the method further comprises:
determining whether another communication device belonging to the user is within a vicinity of the user device, wherein the notification message is sent when another communication device is not determined to be within the vicinity of the user device.

18. The computer readable medium of claim 14, wherein the one or more information items identified in the profile data is preconfigured by a user of the user device.

19. The computer readable medium of claim 14, wherein the method further comprises:
requesting confirmation that the notification message has been received by the contact device.

20. The computer readable medium of claim 19, wherein the method further comprises:
sending another notification message to the contact device when the confirmation has not been received within a threshold period of time, wherein the other notification message is a different type of notification message from the notification message.
